(19) United States
(12) Patent Application Publication
(10) Pub. No.: US 2016/0132961 A1
(43) Pub. Date: May 12, 2016

(54) SYSTEMS AND METHODS FOR FLEXIBLE MERCHANT PRICING

(71) Applicant: PayPal Inc., San Jose, CA (US)

(72) Inventors: Vivek Gupta, Yarrow Point, WA (US); Diwakar Magadi, San Jose, CA (US); Narendran Shanmugasundaram, Anaiyur (IN); Devendrakumarkumar Sriram, Chennai (IN); Saurav Mukherjee, Kolkata (IN); Rajkumar Chandrasekaran, Chennai (IN)

(21) Appl. No.: 14/996,987

(22) Filed: Jan. 15, 2016

Related U.S. Application Data
(63) Continuation of application No. 13/737,515, filed on Jan. 9, 2013.

(51) Int. Cl. G06Q 30/06; G06Q 30/02

(52) U.S. Cl. CPC G06Q 30/0641; G06Q 30/0283

(57) ABSTRACT

One example embodiment relates to a computer-implemented method including receiving from a user, via a network, data relating to an item to be listed for sale at an item price in an electronic marketplace. An interactive pricing page is presented to the user, the pricing page including one or more interface elements to receive a pricing structure relating to the item to be listed for sale, the one or more interface elements allowing the user to define, as part of the pricing structure, at least a first item price and one or more future price changes in the item price during an item listing period. The method includes displaying the item listing with at least the first item price in the electronic marketplace, and automatically changing, during the item listing period, the displayed item price based on the received pricing structure.

### CROSS-REFERENCE TO RELATED APPLICATIONS

This application is a continuation of U.S. patent application Ser. No. 13/737,515, filed on Jan. 9, 2013, titled “SYSTEMS AND METHODS FOR FLEXIBLE MERCHANG PRICING”, which is incorporated herein by reference.

### TECHNICAL FIELD

This application relates generally to systems and methods to facilitate the creation of on-line listings in an electronic marketplace. More particularly, the application relates to pricing items in on-line listings in an electronic marketplace. The application also relates generally to the creation and presentation of listings using a portable electronic device.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2012, EBAY, INC., all Rights Reserved.

### BACKGROUND

Electronic marketplaces are becoming increasingly popular as a way to buy and sell goods. Items are typically offered for sale in association with a purchase price. In an on-line auction, the price may change depending on the bids received and interest in the item. In a web store, pricing may be set by the seller.

### SUMMARY

In an example embodiment, a system comprises at least one module, executing on one or more computer processors, to receive from a user, via a network, data relating to an item to be listed for sale at an item price in an electronic marketplace; present an interactive pricing page to the user, the pricing page including one or more interface elements to receive a pricing structure relating to the item to be listed for sale, the one or more interface elements allowing the user to define, as part of the pricing structure, at least a first item price and one or more future price changes in the item price during an item listing period; display the item listing with at least the first item price in the electronic marketplace; and automatically change, during the item listing period, the displayed item price based on the received pricing structure.

In a further example embodiment, a computer-readable medium includes instructions, which when performed by a machine, cause the machine to perform the operations of receiving from a user, via a network, data relating to an item to be listed for sale at an item price in an electronic marketplace; presenting an interactive pricing page to the user, the pricing page including one or more interface elements to receive a pricing structure relating to the item to be listed for sale, the one or more interface elements allowing the user to define, as part of the pricing structure, at least a first item price and one or more future price changes in the item price during an item listing period; displaying the item listing with at least the first item price in the electronic marketplace; and automatically changing, during the item listing period, the displayed item price based on the received pricing structure.

### BRIEF DESCRIPTION OF THE FIGURES

Some embodiments are illustrated by way of example and not limitation in the figures of the accompanying drawings. Like numerals may refer to like elements.

FIG. 1 is a block diagram depicting a system for delivering on-line listing processes, according to an example embodiment.

FIG. 2 is a block diagram illustrating an environment for operating a mobile device, according to an example embodiment.

FIG. 3 is a block diagram illustrating a mobile device, according to an example embodiment.

FIGS. 4-5 are block diagrams illustrating network-based systems for delivering on-line listing and pricing structure services, according to example embodiments.

FIGS. 6A-6K are screen views illustrating example pricing pages, according to example embodiments.

FIG. 7 is a flowchart illustrating aspects of a method for creating an on-line listing and item pricing structure, according to an example embodiment.

FIG. 8 is a diagrammatic representation of a machine in the example form of a computer system within which a set of instructions for causing the machine to perform any one or more of the methodologies discussed herein may be executed.

### DEFINITIONS

Location—For the purposes of this specification and the associated claims, the term “location” is used to refer to a geographic location, such as a longitude/latitude combination or a street address. The term location is also used within this specification and claims in reference to a physical location associated with a retail outlet (e.g., store).

Real-time—For the purposes of this specification and the associated claims, the term “real-time” is used to refer to calculations or operations performed on-the-fly as events occur or input is received by the operable system. However, the use of the term “real-time” is not intended to preclude operations that cause some latency between input and response, so long as the latency is an unintended consequence induced by the performance characteristics of the machine.

Item—includes a product, a good, or a service.

User—includes a buyer, a seller, a merchant, or other person or entity interacting with a system.

Presenting to—includes sending to, allowing access to, displaying to, publishing or otherwise making available to the general public or a user.

Page—includes a web page, interface or other page presented in the display of a computer or mobile device, for example.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments may be combined, other embodiments may be utilized, or structural, logical and electrical changes may be made without departing from the scope of what is claimed. The following detailed description is, therefore, not to be taken in a limiting sense, and the scope is defined by the appended claims and their equivalents.

In broad terms, the present subject matter provides flexible seller (or merchant) pricing. In some embodiments, the present subject matter allows sellers in a multiple-seller marketplace to define a flexible pricing structure for an item at the time of listing. The seller can specify price changes (increase or decrease) after a certain quantity is sold, or after a specific number of days, or on particular dates. An electronic marketplace hosted by a retailer, web store or on-line auction house, for example, makes available a “flexible pricing” listing feature to allow sellers to define a pricing structure for an item. Price changes can be based, for example, on quantity of items sold, a time remaining before listing expiration, or specific dates. The pricing structure can be defined when the item is listed and item prices are adjusted automatically when the defined conditions (e.g., quantity sold, time remaining, or date) are satisfied.

In some examples, a seller may list a quantity of items for sale. The first ten items may be listed for sale at $10 each, the next 10 items may be listed at $12 each, and so forth. For a price change based on a listing time, an item may be priced for the first five days of the listing at $10 each, and an item price during the next 10 days may be $12 each. In an example based on a listing time remaining, during the last five days of the listing an item price may be set at $15 each. For a price change based on specific dates, pricing for holiday items may increase as the holiday approaches, but decrease during the last two days before the holiday. It will be appreciated that many other examples are possible.

Item prices can be set by a user during the creation of an item listing and in this sense the prices are “predefined” before the item is placed on sale in the open market. The prices are not necessarily determined by market conditions that might occur after the item has been placed on sale in the marketplace, for example. In some examples, the seller may have devised, ahead of time, a comprehensive business strategy for an item that the seller intends to bring to market. The strategy may relate for example to an exciting new product or service in the marketplace, or in other examples to a commonplace product or commodity that has sensitive pricing points. The business strategy may include aspects such as a marketing strategy, a pricing strategy, or a regional strategy that the seller may seek to pursue to maximize the chances of commercial success.

Whether based on a business strategy (or independently of one), the present subject matter allows a seller to predefine a pricing structure for an item either before or during the creation of an on-line listing for that item. A variety of pricing conditions may be specified on which item price changes can be based. In this sense the pricing structure is “flexible”. The price changes defined in the pricing structure can remain active until a price change condition is satisfied, and then the item price automatically changes accordingly. In some examples, no further input from the seller is required. If circumstances should nevertheless change after the item is listed (for example, unprecedented market demand for a new product), then the flexible pricing structure can be amended to suit the new environment.

In some examples, the creation of a pricing structure is facilitated in the provision of an interactive pricing page in which a seller can set prices and input a variety of price change conditions. In some examples, the pricing page is provided by the owner or host of an electronic marketplace. In some examples, the owner or host may charge a fee or commission for use of the pricing page by the seller. The pricing page may in other examples be provided by a user interacting in the electronic marketplace. The pricing page may in some examples be presented in a website, or in the interface of a portable electronic device, for example. In a multiple-seller marketplace, a plurality of pricing structures from a plurality of sellers may be received.

In some examples, the predefined pricing structures (or templates) can saved by the seller and labeled, for example, Strategy 1, Strategy 2, and so forth for quick selection during creation of subsequent listings. The present subject can provide improved pricing flexibility for users. Sellers for example do not need to come back to a listing to enter price changes, and for the host of an electronic marketplace a new revenue stream can be created if the “flexible pricing” page is offered as a paid feature. Business entities can take more control of their own profitability. The present subject matter provides flexible options for sellers to match prices of listed items with their business strategy.

### Example System

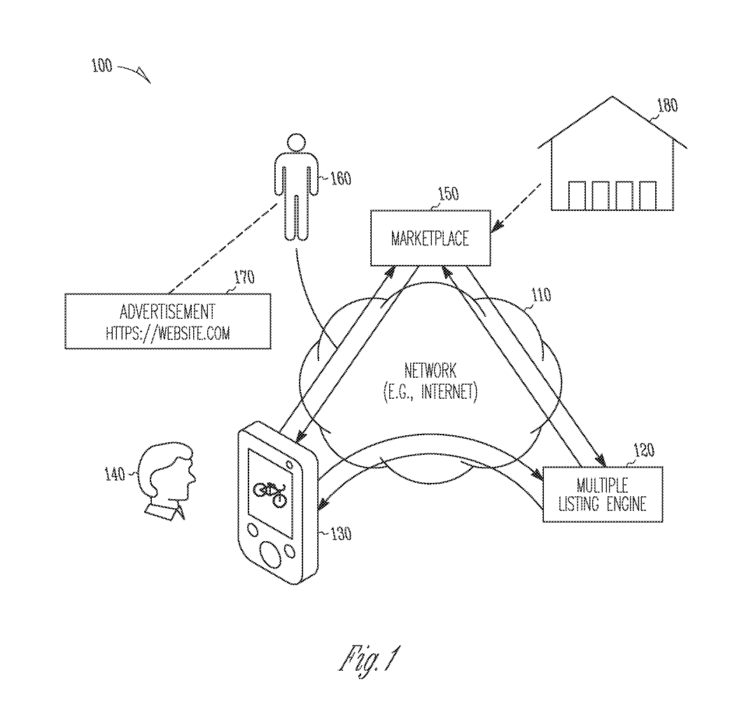

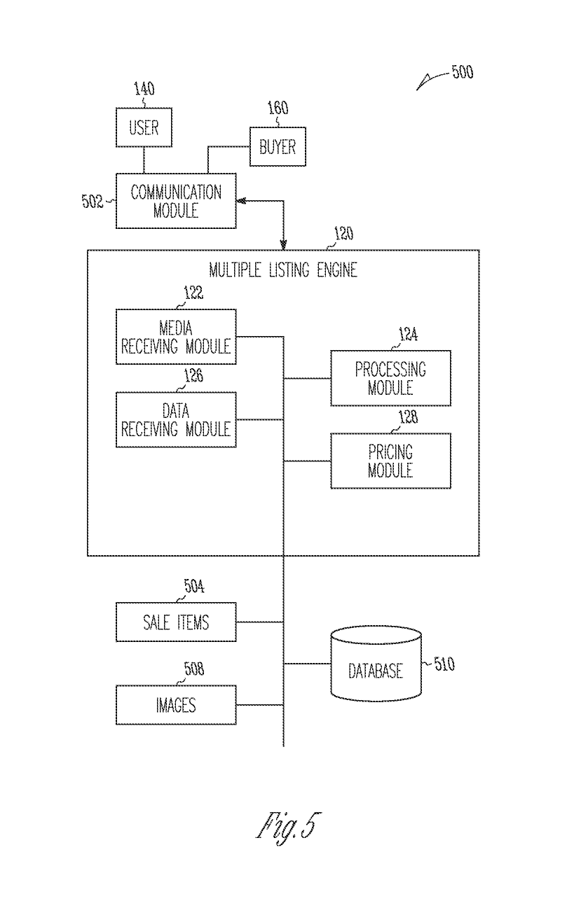

Some example embodiments of systems and methods for creating on-line marketplace listings of items for sale are described herein. FIG. 1 illustrates an example environment 100 that may include a computer network 110, a multiple listing engine 120, an electronic device 130, a user 140, an electronic marketplace 150, buyers 160, and sample advertising 170. The electronic marketplace 150 may offer items for sale in on-line listings. The network 110 may have multiple data processing nodes interconnected for the purpose of data communication. The electronic device 130 may include a desktop computer, laptop computer, mobile device (e.g., cell phone, PDA, global positioning system) or any other electronic device that is capable of interacting with the computer network 110. The multiple listing engine 120 facilitates the predefinition of flexible pricing structures during the creation of the on-line listings and is described in more detail below with reference to FIG. 5. The electronic device 130 may include a Graphical User Interface (GUI) that can be manipulated by the user 140. The GUI may offer text menus or require typed commands. The GUI may also allow the input of gestures or other alternative input like voice or visual commands. In alternative forms, the electronic device 130 may be configured to utilize icons in conjunction with text, labels, voice commands or text navigation to represent the information and actions available to the user 140.

The user 140 may be a person interacting with the electronic device 130 via the GUI. A user 160 may also be a person interacting with a respective electronic device 130 via a GUI. An electronic device 130 can access, via the network 110, the electronic market place 150 and multiple listing engine 120 to view or create the items listings. The electronic marketplace 150 can also create or host item listings, as is explained in more detail below.

The electronic marketplace 150, in the context of the illustrated example network environment 100, may be an online auction and/or a fixed-price shopping website configured to permit individual users and businesses to buy and sell goods and services (e.g., eBay.com, Amazon.com, or Milo.com). The electronic marketplace 150 may be a part of worldwide electronic commerce, which includes buying and selling of products or services over electronic systems such as the Internet and other computer networks. The electronic marketplace 150 may have an associated “bricks-and-mortar” retail store or outlet 180 (e.g., Target®, Walmart®), or an associated distributor or warehouse 180, for example.

The advertising 170 may include information as to where buyers 160 can view the items for sale that are part of the electronic marketplace 150 on the computer network 110, or available at the associated retail store 180. As examples, the advertising 170 may be included in a road-side sign, a brochure, a banner, or in some other form of advertising that would provide information to the potential buyers that are near the retail store 180 for example. Other advertising methods are possible. The particular information on the advertising 170 that lets buyers 160 know where they can view the items that are part of the electronic marketplace 150 or retail store 180 may take the form of a web address (e.g., https://website.com). In some embodiments, the advertising includes online or virtual advertisements. Embodiments of the advertising 170 can include informational material and physical (e.g. building sign) and on-line (e.g. website based) advertisements. The advertising 170 may include different options used in conjunction with each other as part of an overall marketing campaign or business strategy. In some embodiments, advertisements featuring the electronic marketplace 180 are used in conjunction with marketing efforts or devices relating to “bricks-and mortar” stores, or other mainstream on-line commerce, such as eBay, craigslist.com, RedLaser™ or Milo.com electronic market places.

In some embodiments, the advertising 170 includes information related to preferred purchasing opportunities that are available to buyers 180 when using the information contained in the advertisement 170 to access the listings on the computer network 110. As examples, user 140 may (i) offer the ability to purchase the items via the computer network 110 before the item is launched in a retail store 180; and/or (ii) provide a purchasing incentive (e.g., a discount) for people that use the computer network 110 to purchase any of the items that are part of the electronic marketplace 150, or retail store 180.

### Example Operating Environment

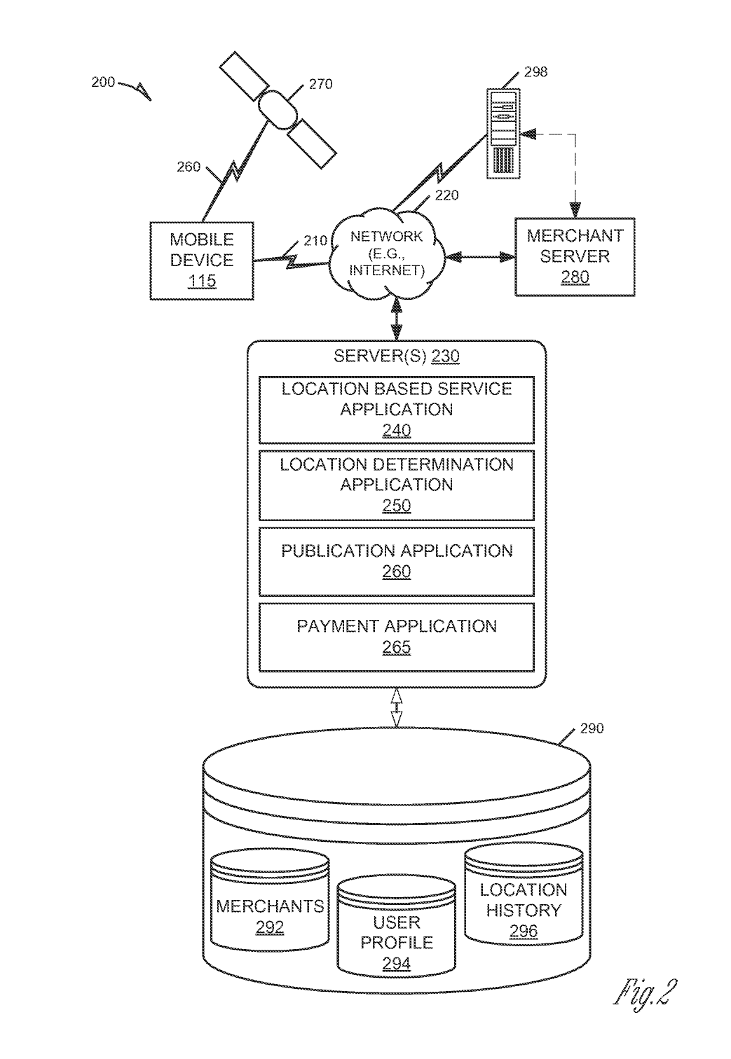

FIG. 2 is a block diagram illustrating an environment for operating a mobile device, according to an example embodiment. A mobile device can be used to implement aspects of the methods described herein. The environment 200 is an example environment within which methods of creating on-line listings of items for sale can occur. The item listings can include flexible pricing structures of the type described herein.

The environment 200 can include a mobile device 115, a communication connection 210, a network 220, servers 230, a communication satellite 270, a merchant (or seller) server 280, and a database 290. The merchant server 280 can include applications to interact with or support on-line listings of items in the electronic marketplace 150 (FIG. 1) or retail store 180 (FIG. 1). The servers 230 can optionally include location based service application 240, location determination application 250, publication application 260, and payment application 265. The database 290 can optionally include merchant databases 292, user profile database 294, and/or location history database 296. The mobile device 115 represents one example device that can be utilized by a user to create on-line listings, define price changes in flexible pricing structures, save pricing structure templates, retrieve pricing structure templates, receive advertising or offers, and process payments in purchasing listed items for sale, for example. The mobile device 115 may be any of a variety of types of devices (for example, a cellular telephone, a personal digital assistant (PDA), a Personal Navigation Device (PND), a handheld computer, a tablet computer, a notebook computer, or other type of movable device). The mobile device 115 may interface via a connection 210 with a communication network 220. Depending on the form of the mobile device 115, any of a variety of types of connections 210 and communication networks 220 may be used.

For example, the connection 210 may be Code Division Multiple Access (CDMA) connection, a Global System for Mobile communications (GSM) connection, or other type of cellular connection. Such connection 210 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks). When such technology is employed, the communication network 220 may include a cellular network that has a plurality of cell sites of overlapping geographic coverage, interconnected by cellular telephone exchanges. These cellular telephone exchanges may be coupled to a network backbone (for example, the public switched telephone network (PSTN), a packet-switched data network, or to other types of networks).

In another example, the connection 210 may be Wireless Fidelity (Wi-Fi, IEEE 802.11x type) connection, a Worldwide Interoperability for Microwave Access (WiMAX) connection, or another type of wireless data connection. In such an embodiment, the communication network 220 may include one or more wireless access points coupled to a local area network (LAN), a wide area network (WAN), the Internet, or other packet-switched data network. In yet another example, the connection 210 may be a wired connection, for example an Ethernet link, and the communication network may be a LAN, a WAN, the Internet, or other packet-switched data network. Accordingly, a variety of different configurations are expressly contemplated.

A plurality of servers 230 may be coupled via interfaces to the communication network 220, for example, via wired or wireless interfaces. These servers 230 may be configured to provide various types of services to the mobile device 115 and may work in conjunction with the merchant server 280 in providing them. For example, one or more servers 230 or 280 may execute on-line listing services and present to a user an interactive pricing page when a listing is created. The pricing page may allow a user to predefine price changes relating to an item intended to be placed on sale in the electronic market place 150 or retail store 180. The pricing changes may be based on a user's business strategy, for example. The servers 230 may also provide services to allow users to search for or review on-line listings in the electronic market 150 or store 180.

In some examples, the servers 230 may execute location based service (LBS) applications 240, which interoperate with software executing on the mobile device 115, to provide LBSs to a user. LBSs can use knowledge of the device's location, and/or the location of other devices, to provide location-specific information, recommendations, notifications, interactive capabilities, and/or other functionality to a user. For example, an LBS application 240 can provide location data to a network-based user check-in system 298 associated with the electronic marketplace 150 or retail store 180, via merchant server 280 for example, which can then be used to assist in generating offers of items for sale in the marketplace 150 or store 180. The offers may be relevant to the user's current location. The offers may enable or facilitate payment via the network-based payment application 265.

Knowledge of the device's location, and/or the location of other devices, may be obtained through interoperation of the mobile device 115 with a location determination application 250 executing on one or more of the servers 230. Location information may also be provided by the mobile device 115, without use of a location determination application, such as application 250. In certain examples, the mobile device 115 may have some limited location determination capabilities that are augmented by the location determination application 250. In some examples, the servers 230 can also include publication application 260 for providing location-aware offers that may be triggered by present or past check-ins with the network-based check-in service 298. In certain examples, location data can be provided to the publication application 260 by the location determination application 250. In some examples, the location data provided by the location determination application 250 can include merchant information (e.g., identification of a retail location 180, or on-line web-store 150). In certain examples, the location determination application 250 can receive signals via the network 220 to further identify a location. For example, a merchant may broadcast a specific IEEE 802.11 service set identifier (SSID) that can be interpreted by the location determination application 250 to identify a particular retail location. In another example, the merchant may broadcast an identification signal via radio-frequency identification (RFID), near-field communication (NFC), or a similar protocol that can be used by the location determination application 250.

### Example Mobile Device

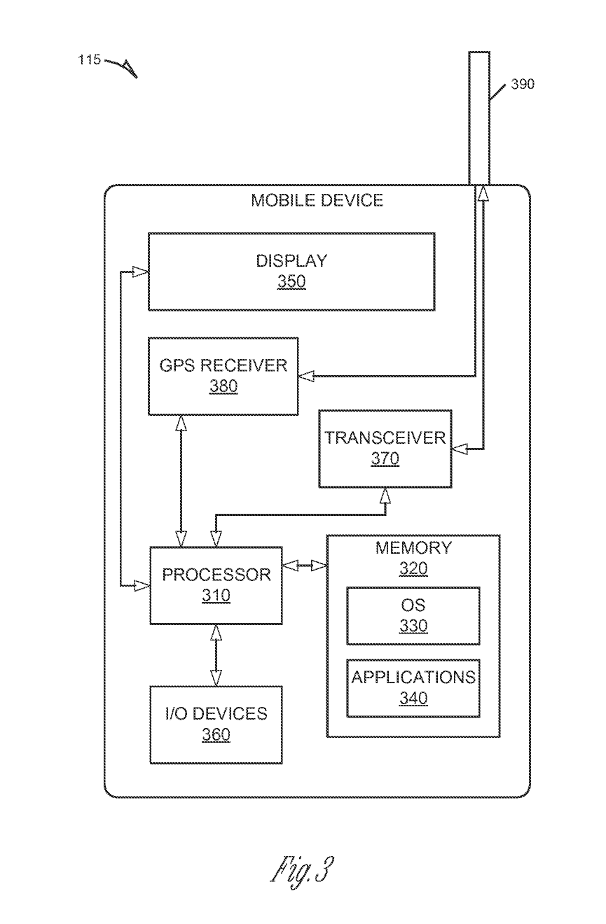

FIG. 3 is a block diagram illustrating a mobile device, according to an example embodiment. The mobile device 115 may include a processor 310. The processor 310 may be any of a variety of different types of commercially available processors suitable for mobile devices (for example, an XScale architecture microprocessor, a Microprocessor without Interlocked Pipeline Stages (MIPS) architecture processor, or another type of processor). A memory 320, such as a Random Access Memory (RAM), a Flash memory, or other type of memory, is typically accessible to the processor. The memory 320 may be adapted to store an operating system (OS) 330, as well as application programs 340, such as a mobile location enabled application that may provide LBSs to a user. The processor 310 may be coupled, either directly or via appropriate intermediary hardware, to a display 350 and to one or more input/output (I/O) devices 360, such as a keypad, a touch panel sensor, a microphone, and the like. Similarly, in some embodiments, the processor 310 may be coupled to a transceiver 370 that interfaces with an antenna 390. The transceiver 370 may be configured to both transmit and receive cellular network signals, wireless data signals, or other types of signals via the antenna 390, depending on the nature of the mobile device 115. In this manner, the connection 210 with the communication network 220 may be established. Further, in some configurations, a GPS receiver 380 may also make use of the antenna 390 to receive GPS signals.

### Example Platform Architectures

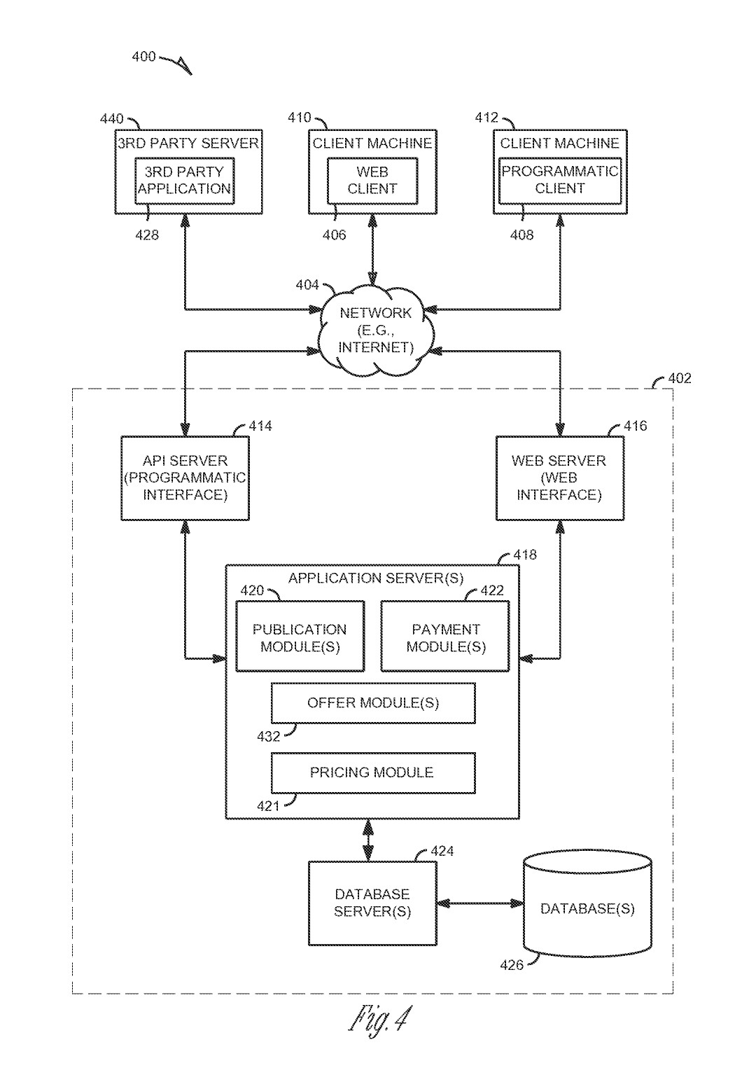

FIG. 4 is a block diagram illustrating a network-based system 400 for delivering on-line listing and pricing structure services, according to an example embodiment. The block diagram depicts a network-based system 400 (in the exemplary form of a client-server system), within which an example embodiment can be deployed is described. A networked system 402, in the example form of a network-based on-line listing system, provides server-side functionality, via a network 404 (e.g., the Internet or WAN) to one or more client machines 410, 412. FIG. 4 illustrates, for example, a web client 406 (e.g., a browser, such as the Internet Explorer browser developed by Microsoft Corporation of Redmond, Wash. State) and a programmatic client 408 (e.g., WHERE™ smartphone application from Where, Inc. of Boston, Mass. or FOURSQUARE™ smartphone application from Foursquare, Inc. of New York, N.Y.) executing on respective client machines 410 and 412. In an example, the client machines 410 and 412 can be in the form of a mobile device, such as mobile device 115.

An Application Programming Interface (API) server 414 and a web server 416 are coupled to, and provide programmatic and web interfaces respectively to, one or more application servers 418. The application servers 418 host one or more publication modules 420 (in certain examples, these can also include commerce modules, advertising modules, and marketplace modules, to name a few), pricing modules 421, payment modules 422, and location-aware offer modules 432. The application servers 418 are, in turn, shown to be coupled to one or more database servers 424 that facilitate access to one or more databases 426. In some examples, the application server 418 can access the databases 426 directly without the need for a database server 424.

The publication modules 420 may provide a number of publication functions and services to users that access the networked system 402. The pricing module 421 may present a number of pricing services, for example including presentation of a pricing page when an item listing is created by a user. The pricing page may include action elements or interfaces allowing a user to predefine one or more conditions on which future item price changes may be based. Examples of user interfaces presented in a pricing page are illustrated in the screenshots described below. The pricing module may be configured to implement any of the pricing methods and features described in this specification. The payment modules 422 may likewise provide a number of payment services and functions to users. The payment modules 422 may allow users to accumulate value (e.g., in a commercial currency, such as the U.S. dollar, or a proprietary currency, such as “points”) in accounts, and then later to redeem the accumulated value for products (e.g., goods or services) that are advertised or made available via the various publication modules 420, within retail locations, or within external online retail venues. The payment modules 422 may also be configured to present or facilitate a redemption of offers, generated by the location-aware offer modules 432, to a user during checkout (or prior to checkout, while the user is still actively shopping). The payment modules 422 can also be configured to enable check-in based payment processing. The location-aware offer modules 432 may provide real-time location-aware offers (e.g., coupons or immediate discount deals on targeted products or services) to users of the networked system 402. The location-aware offer modules 432 can be configured to use all of the various communication mechanisms provided by the networked system 402 to present offer options to users. The offer options can be personalized based on current location, time of day, user profile data, past purchase history, or recent physical or online behaviors recorded by the network-based system 400, among other things. While the publication modules 420, pricing modules 421, payment modules 422, and location-aware offer modules 432 are shown in FIG. 4 to all form part of the networked system 402, it will be appreciated that, in alternative embodiments, the pricing modules 421 or payment modules 422 may form part of a pricing or payment service that is separate and distinct from the networked system 402. Additionally, in some examples, the location-aware offer modules 432 may be part of the pricing or payment service or may form an offer generation service separate and distinct from the networked system 402. In certain examples, the network-based check-in service 298 can include some or all of the application severs 418.

Further, while the system 400 shown in FIG. 4 employs client-server architecture, the present invention is of course not limited to such an architecture, and could equally well find application in a distributed, or peer-to-peer, architecture system, for example. The various publication modules 420, pricing modules 421, payment modules 422, and location-aware offer modules 432 could also be implemented as standalone systems or software programs, which do not necessarily have networking capabilities.

The web client 406 accesses the various publication modules 420, pricing modules 421, payment modules 422, and location-aware offer modules 432 via the web interface supported by the web server 416. Similarly, the programmatic client 408 accesses the various services and functions provided by the publication modules 420, pricing modules 421, payment modules 422, and location-aware offer modules 432 via the programmatic interface provided by the API server 414. The programmatic client 408 may, for example, be a smartphone application (e.g., the PAYPAL™ payment application developed by eBay, Inc., of San Jose, Calif.) to enable users to make a various of payments directly from their smartphones.

FIG. 4 also illustrates a third party application 428, executing on a third party server machine 440, as having programmatic access to the networked system 402 via the programmatic interface provided by the API server 414. For example, the third party application 428 may, utilizing information retrieved from the networked system 402, support one or more features or functions on a website hosted by the third party. The third party website may, for example, provide one or more promotional, marketplace, pricing or payment functions that are supported by the relevant applications of the networked system 402. Additionally, the third party website may provide merchants (sellers) with access to local pricing modules 421 or location-aware offer modules 432 for configuration purposes. In certain examples, merchants can use programmatic interfaces provided by the API server 414 to develop and implement rules-based pricing schemes and pricing structures that can be implemented via the publication modules 420, pricing modules 421, payment modules 422, and location-aware offer modules 432.

Reference is now made to FIG. 5 which is a block diagram that shows another example architecture for a system 500 for creating and displaying on-line listings of items for sale in an electronic marketplace 150 or retail store 180 (FIG. 1). The system 500 includes a communication module 502 coupled to a multiple listing engine 120.

The system 500 may further include sale items 504, images 508, and a database 510. The communication module 502 is configured to receive a request from a user 140 to list one or more sale items 504 on the computer network 110 that are intended to be offered for sale in the electronic marketplace 150 or retail store 180. In an example embodiment, the communication module 502 is configured to receive via the network 110 from the user 140 a listing of one or more items for sale 504 that offered for sale, and present via the network 110 at least part of the item listing to one or more buyers 160 connected to the network 110. The communication module 502 may receive a predefined pricing structure from a user as the item listing is created. The term “presenting” may include sending, allowing access to, or displaying to a user 140 or a buyer 160 at least a portion of the item listing. The term “presenting” may also include publishing or otherwise making available such content to the general public via the network 110, such as the internet for example. The listing may include only one item for sale. The listing may include information about the one or more items included in the listing.

In an example embodiment, the creation or viewing of an item listing may be performed by a user 140 or buyer 160 using the GUI on a respective electronic device 130 (mobile device 115 in FIGS. 2-3). A request to search the item listing, view search results or a specific item for sale, or create or place an item in an on-line listing in the electronic marketplace 150 or retail store 180, may also be performed using an electronic device 130. Item listings for fixed or temporary seller locations such as warehouses or garage sales located within a defined geographic region or at a defined location, such as a specific address, or a region defined by a ZIP code, or a region proximate the user 140 or buyer 160 (for example within a defined radius), may be created, identified, viewed or searched by a user 140 or buyer 160. These actions may be performed by the user 140 or buyer 160 using an electronic device 130. In some embodiments, the region may be defined by the automatic selection of a region by a module within the system 400 in response to a received request, or by the user 140 or a buyer 160. The user/buyer actions may be performed using a software application installed on the electronic device 130.

The multiple listing engine 120 may include various components that facilitate listing the sale items 504 in the on-line listings of the electronic marketplace 150 or retail store 180. The item listings may be placed in an electronic marketplace 150, such as eBay.com, Amazon.com, craigslist.com, or Milo.com for example. It will be appreciated that many listing compositions and permutations are possible. As an example, the multiple listing engine 120 may include a media receiving module 122, a processing module 124, a data receiving module 126, and a pricing module 128. In some embodiments, the processing module 124 is be configured to list the sale items 504 for sale. The data receiving module 126 may be configured to receive data from the user 140, a buyer 160, or the database 510.

The pricing module 128 may present a number of pricing services. For example, a pricing service may include presenting a pricing page to a user when an item listing is created. The pricing page may include action elements or interfaces allowing a user to predefine one or more conditions on which future item price changes may be based. Examples of user interfaces presented in a pricing page are illustrated in the screenshots described below. The pricing module may be configured to implement any of the pricing methods and features described in this specification.

The database 510 may include data that is associated with the sale items 504 (e.g. pricing structures, inventories, item specifications, and so forth), the user 140 or buyer 160, the electronic marketplace place 150 or retail store 180 (e.g., location and hours of operation). In addition, the database 510 may be a single database, or a combination of databases that are configured as a structured collection of records or data. The relevant data may be stored in the electronic device 130 and/or another electronic device that is connected the computer network 110 (e.g., an electronic device that forms parts of the electronic marketplace 150). In some embodiments, a listing of items for sale is received from a user 140 and includes an item identification element including one or more of a product descriptor, an image, a bar code, or a decoded bar code. The item identification element may include an element sourced from a website or an element sourced by the user 140 via a photo or bar code imaging application (e.g. RedLaser™) on an electronic device 130, for example.

The communication module 502 is able to receive requests from buyers via the computer network 110 to identify, search or review the item listings. The item listings may include one or more of the sale items listed on the electronic marketplace 150 or retail store 180. A search or other request may include an item identification element including one or more of a product descriptor, an image, a bar code, or a decoded bar code, for example. The item identification element may include an element sourced from a website or an element sourced by a buyer 160 via a photo or bar code imaging application (e.g. RedLaser™) on an electronic device 130, for example. The processing module 124 may search the item listing using the received item identification element. In response to a received request, the relevant information can be obtained from the database 510 once the buyer 160 accesses the multiple listing engine 120 through the communication module 502 using the information in the advertising 170 (FIG. 1), or as included in an item identification element.

In some embodiments, the communication module 502 is configured to receive a request via the network 110 from a buyer 160 to purchase at least one of the items listed for sale. In response to such a request, the communication module 502 may send or display a pricing discount to a buyer 160 submitting the purchase request, or a request to search the item listing, before the item has been offered for sale at a physical location (e.g., retail store 180). Pricing discounts may be offered to buyers 160 that come through a particular advertising source 170 (e.g. an on-line advertisement), or that use a QR code or an image in their search request. Other discounts may be offered to buyers that are located in a particular area, for example, or that have a particular business relationship with the seller 140.

Working in conjunction with the processing module 124 for example, the communication module 502 can in some embodiments allow a buyer 160 to purchase at least one of the items listed for sale using an internet based payment action element, such as PayPal™ for example. As discussed above, the database 510 (or databases) may store information related to purchasing preferences for buyers 160 that view the listing using the information provided in the advertising 170. In some embodiments, the information related to purchasing preferences for buyers 160 that view the listing using the information provided in the advertising 170 may be obtained from another database (not shown in the accompanying figures) that can be accessed via the computer network 110.

In some embodiments, the media receiving module 122 may be configured to receive the images 508 over the computer network 110 that are associated with the sale items 504. The user 140 may supply the images 508 via the electronic device 130. Depending on the type of data that is provided by the user 140 for the sale items 504, the sale items 504 may be extracted from images 508 that are received by the media receiving module 122 and/or the data that is received by the data receiving module 126.

The data in the database 510 (including pricing structures) may be utilized in creating the listing of the items 504 by the multiple listing engine 120, or in response to a query by any user for information about items listed for sale. In addition, the database 510 may store the images 508 as well as any other data that is associated with the sale items 504.

Items offered for sale in on-line listings can be included in mainstream on-line or retail commercial offerings, or in on-line auction listings, and enjoy increased publicity accordingly. Sellers can benefit from this additional exposure to potential buyers. Equally, prospective buyers searching the web for a desired item to purchase have greater depth of content to review. In some examples, buyers can identify specific items to purchase locally or within a defined geographic region, or at a location, of interest. Local buyers can be put in contact with local sellers, and vice versa. The scope of potential commerce can also be supplemented by items offered for sale at temporary seller locations, or offered in the “informal” market sector.

### Example Flexible Pricing Pages

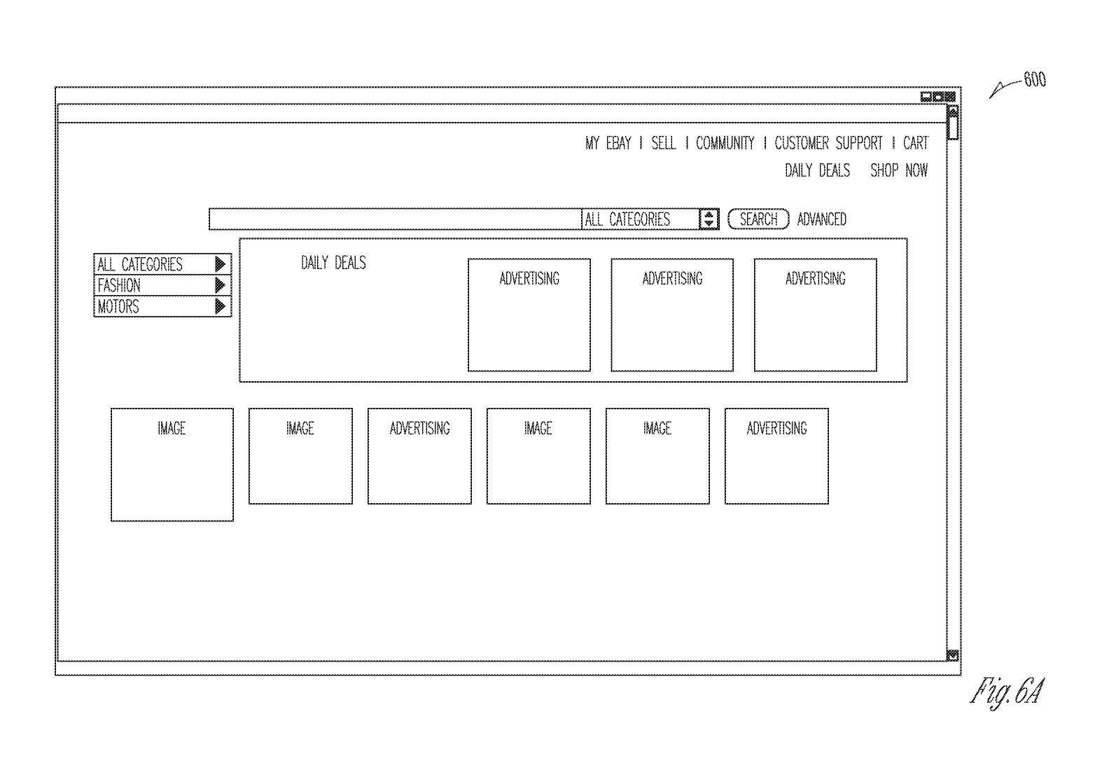

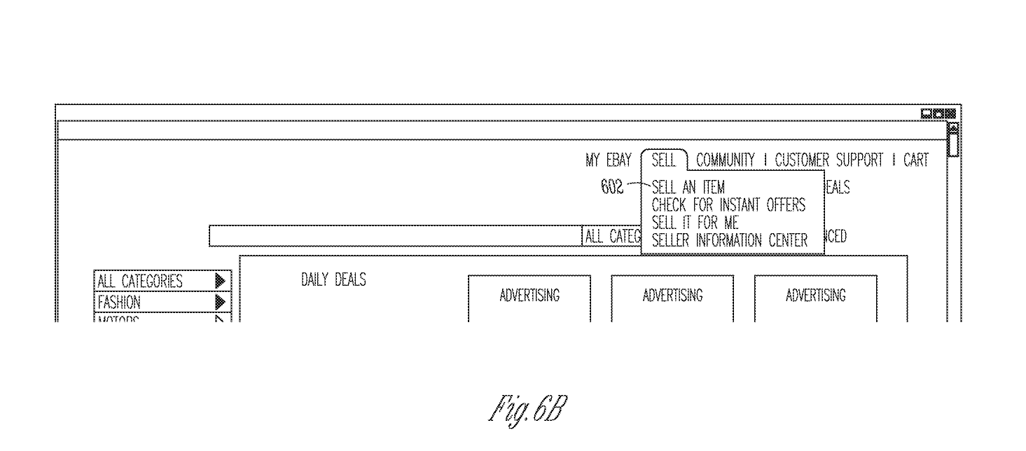

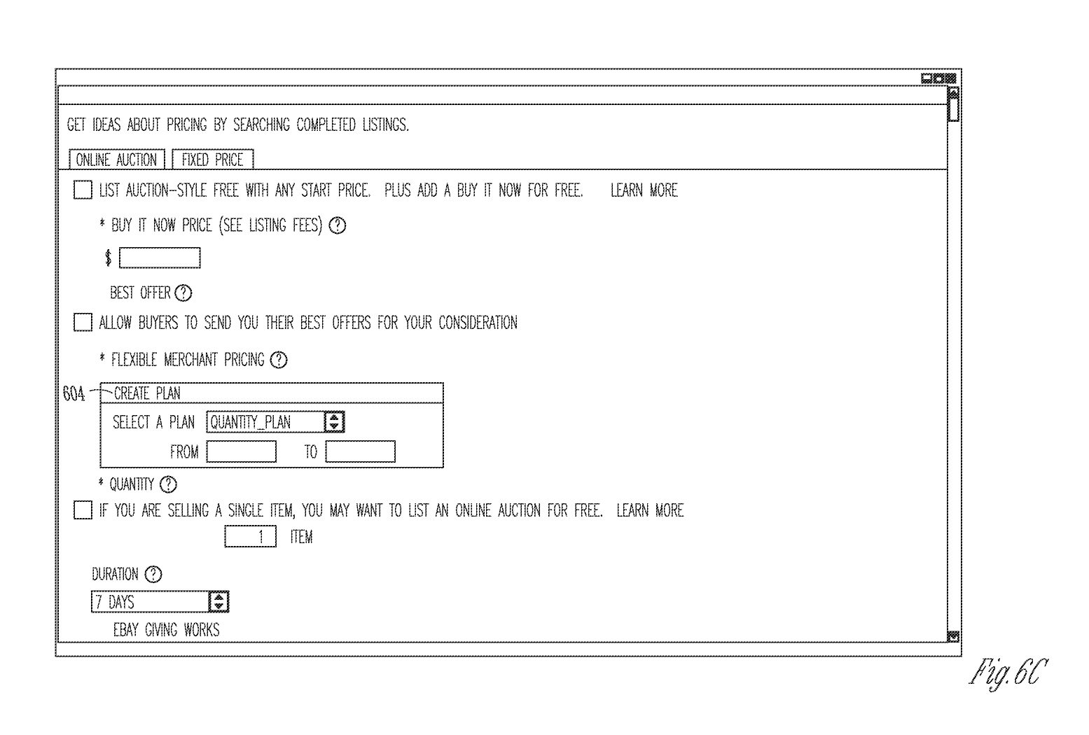

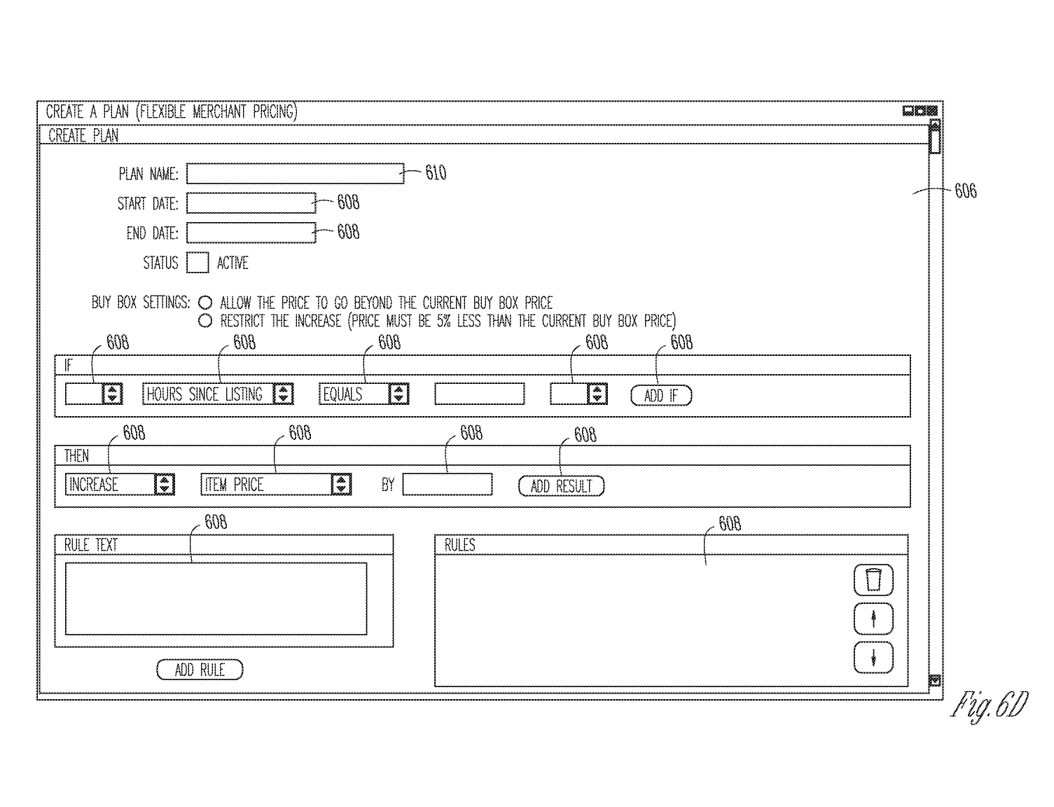

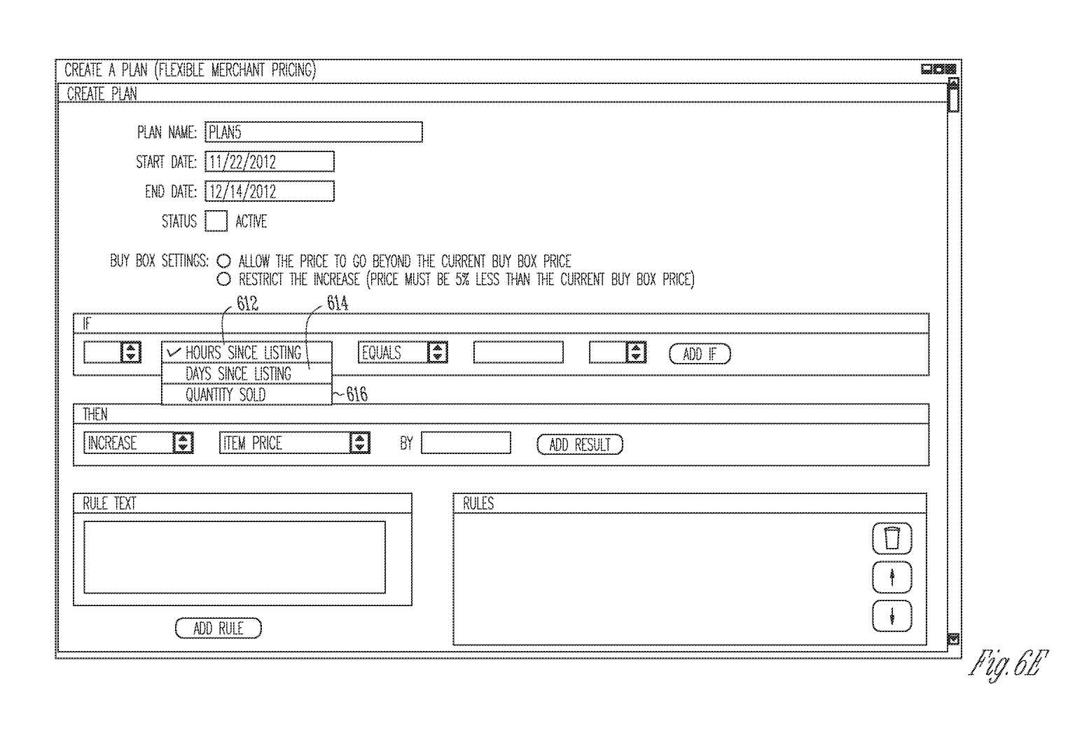

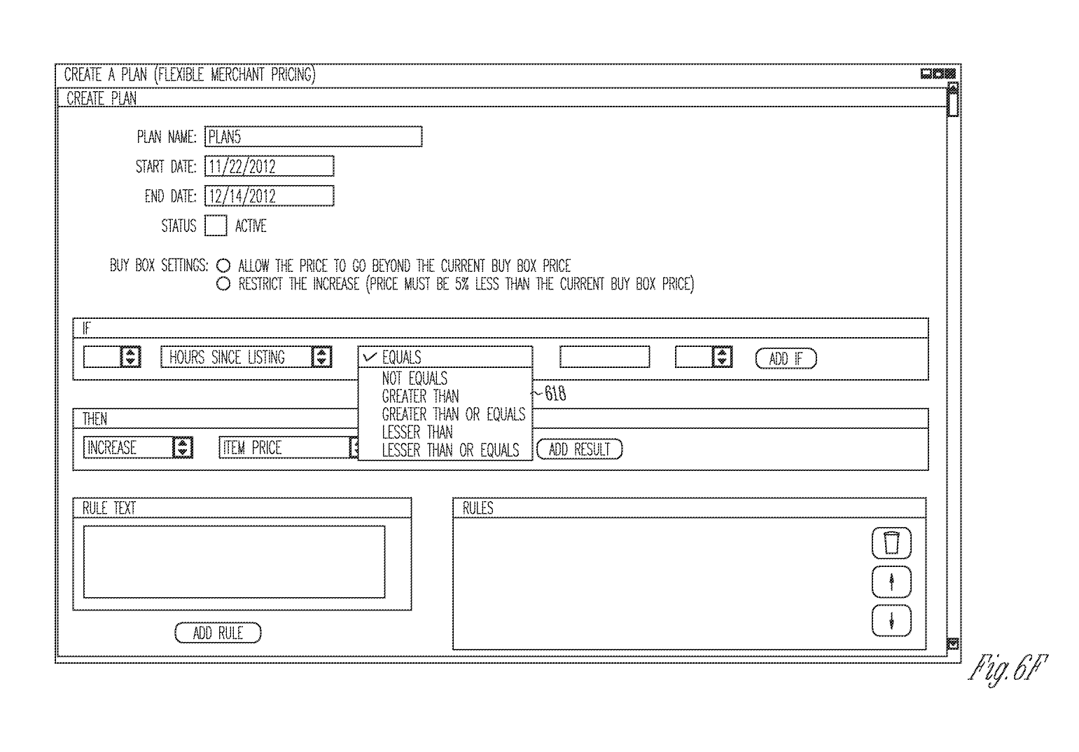

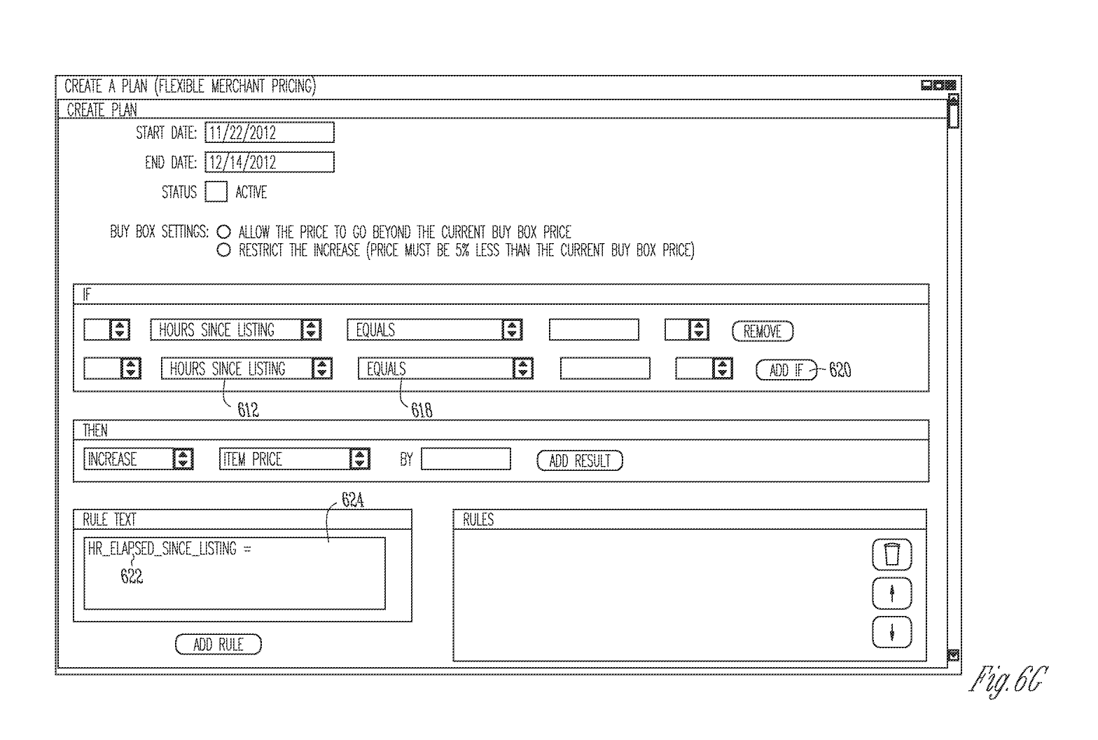

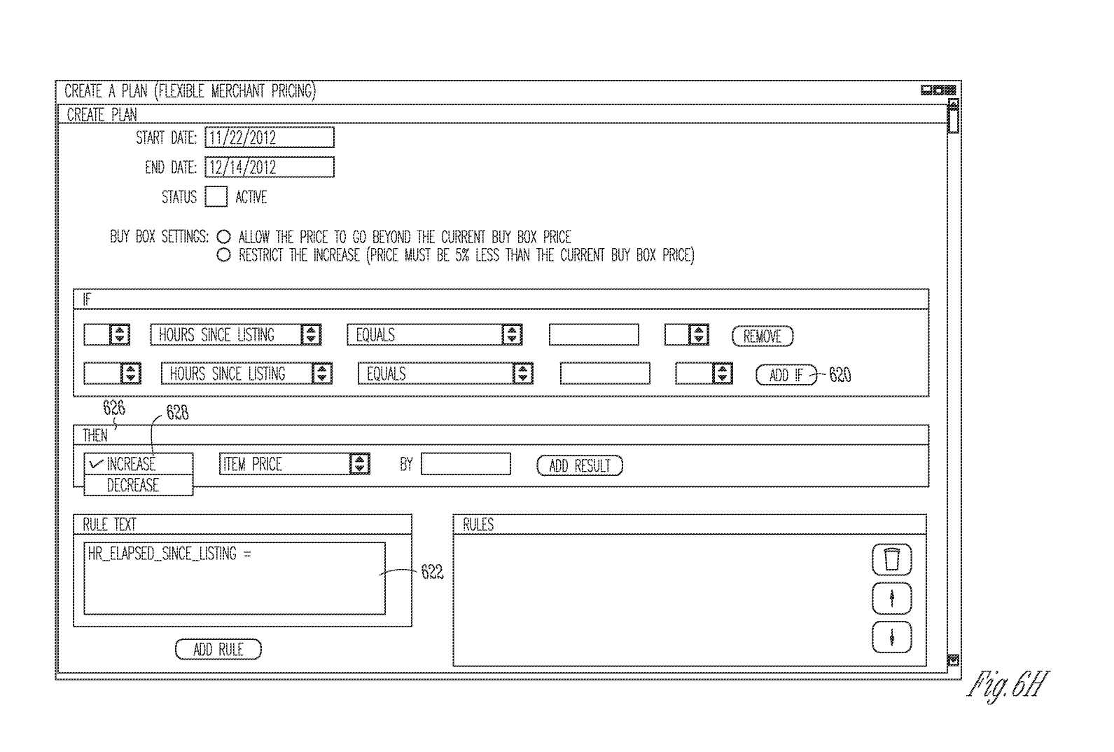

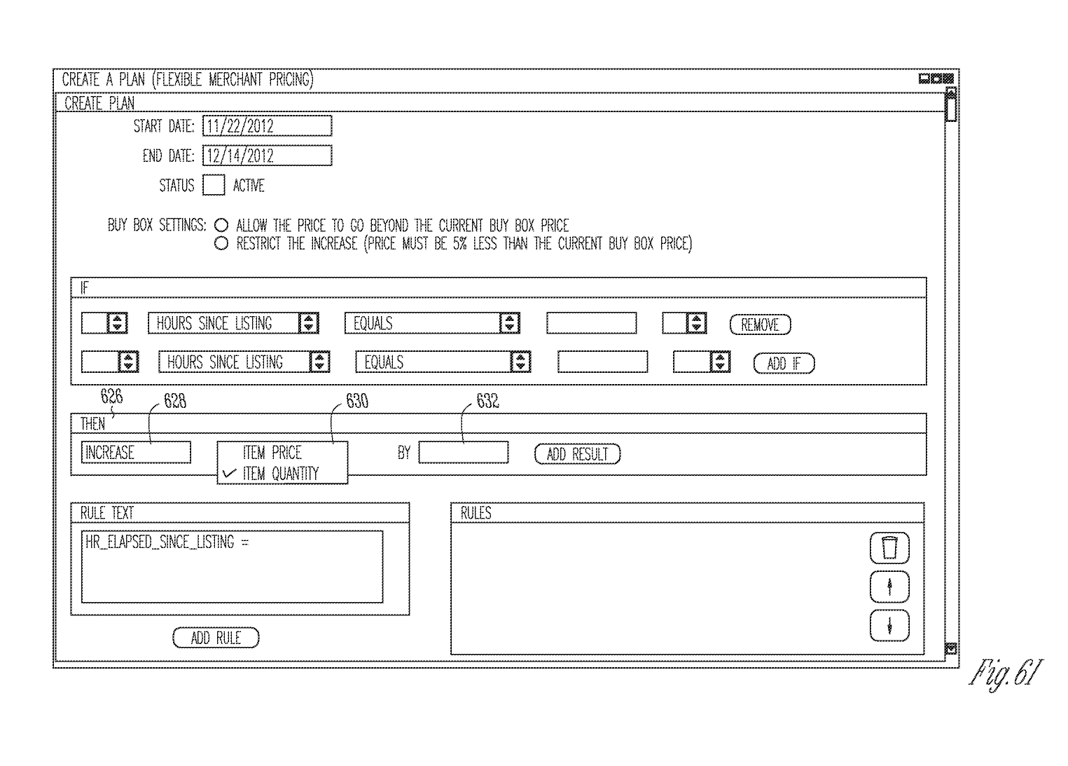

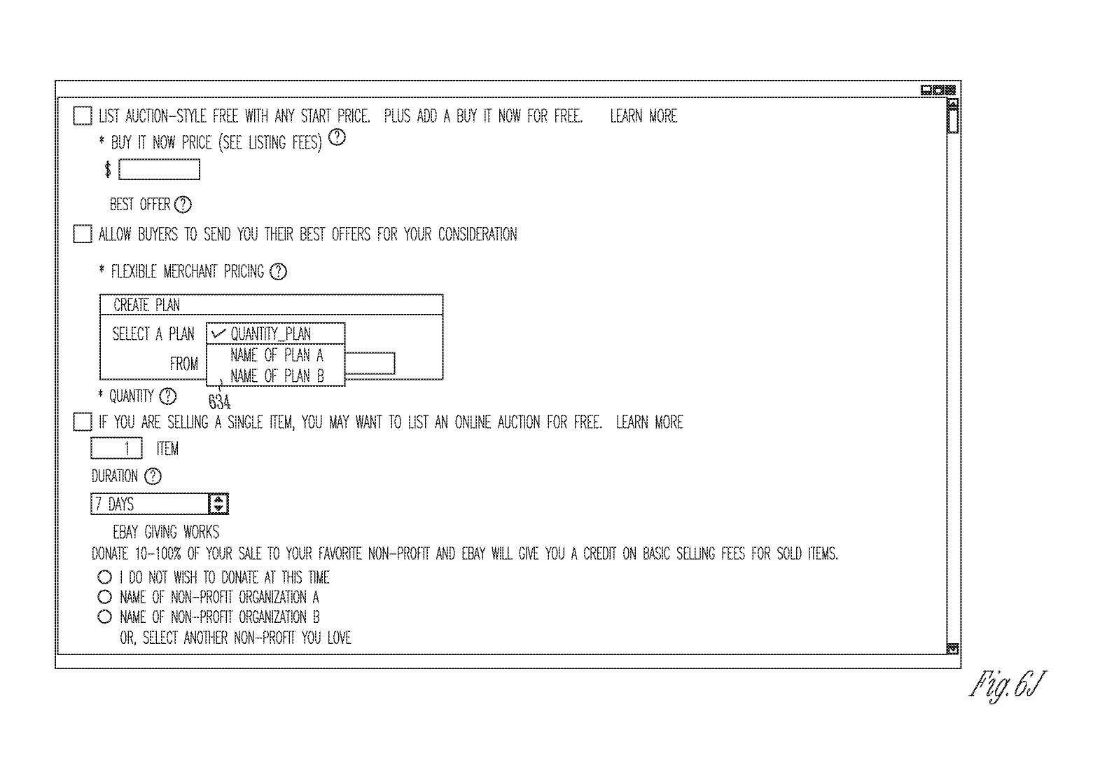

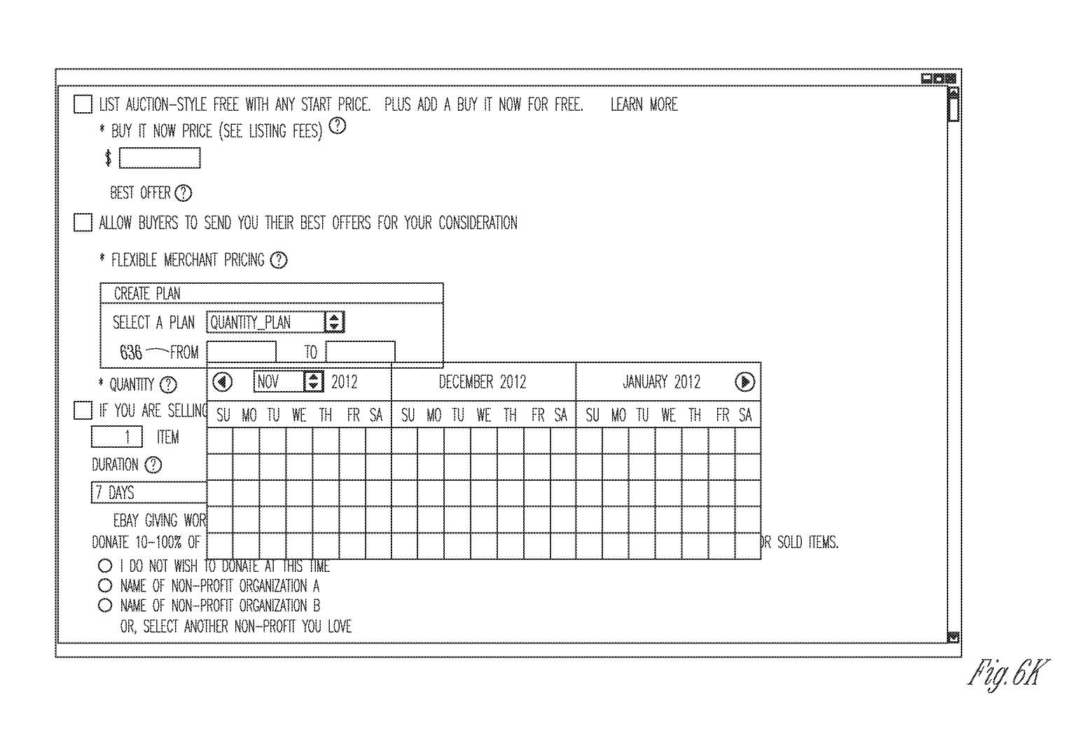

FIGS. 6A-6K illustrate some example screenshots of flexible merchant pricing pages according to the present subject matter. Generally speaking, the illustrated pricing pages will be seen to include one or more interface elements to receive a pricing structure relating to an item to be listed for sale. The interface elements allow the user to define, as part of the pricing structure, a first item price and one or more future price changes in the item price during an item listing period. In some embodiments, the interface elements allow the user to define pricing rules. The item listing is displayed with the first item price in the electronic marketplace and the displayed item price automatically changes during the item listing period based on the received pricing structure.

A user may interact with the interface elements of an interface (for example web page or electronic screen 600 below) through the use of an input device (e.g., stylus, cursor, mouse, finger) of a user terminal. In an embodiment, a user selection is based on the coordinates of the input device as it makes contact with the display or where a user “clicks” the mouse. The coordinates are compared to the coordinates of the user input element to determine the selection. The type of user elements, names, and layout depicted in FIGS. 6A-6K are intended to be an illustration of an example user interface of a flexible pricing system 400 or 500 described in more detail elsewhere in this specification. Other types of user elements, names, and layouts may be used. Some elements may be omitted in various embodiments depending on the nature of the flexible pricing facility provided.

The screen views provided in FIGS. 6A-6K will facilitate an overview of how a method of flexible merchant pricing can work in some examples. In some examples, the method can be performed in a Sell-Your-Item (“SYI”) flow. An example screen-shot of a merchant page 600 is shown in FIG. 6A. The information displayed in the page may include text, graphics, animations, or other aspects. Examples of information may include product listings, a product title, a short description, an item price, a picture of one or more products, a merchant's logo, or the like. Certain additional features that may not appear on the illustrated page may also be included. Examples of these additional features may include cross-sells (i.e. related products), social media info, advertisements or general widgets of a standard e-commerce offering. Action elements may be any user interactive element which allows the user to act upon the product information in some way. Example action elements include buttons which allow users to navigate to other portions of the page (e.g., a “click to return to the top of the page” button), make purchasing decisions (e.g., add-to-cart, buy now with paypal), adding the item to wish lists, layaway, registries (e.g., baby registry, wedding shower registry, or the like), links to send a description of the item to a friend, or the like. In some examples, the action element may be a subset of the action elements which already exist on the website. Upon a user interaction with the action elements, the action elements may trigger the execution of one or more scripts. In some examples, these scripts may carry out the desired functions of the action element (e.g., adding the item to the consumer's digital shopping cart).

In FIG. 6B, a user selects Sell an Item flow from a menu option in the drop down menu 602, as shown. In FIG. 6C showing a view of the next page, a user chooses Create a Plan (i.e. a pricing plan, or pricing structure) at 604. An interactive pricing page, for example as shown in FIG. 6D at 606, is presented to a user. The page 606 includes interface elements, generally designated by the numeral 608, which allow the user to define, as part of the item pricing plan, a first item price and one or more future price changes in the item price during an item listing period. The user gives the plan a name at 610 and begins to enter plan information based on their own unique pricing or business strategy. In FIG. 6E, an example plan is based on various conditions (currently only showing Hours Since listing 612, Days since listing 614, and Quantity sold 616. There can be many conditions. The objective is to be very flexible so plans can be formulated based on unique strategies of individual users. In FIG. 6F, a variety of criteria 618 is presented (in some examples, criteria such as equals, greater than, and so forth) for selection by the user as part of the pricing plan. In FIG. 6G, once the relevant criterion 618 has been selected the Add Ifinterface element 620 is clicked and a pricing plan rule 622 is displayed in the Rule Text box 624. FIG. 6H shows the Then part of the rule at 626, on other words what should the plan do (or, how should the item price be adjusted) if the added If condition is met. In the illustrated example, the Increase option is selected as indicated by the check sign at box 628. FIG. 6I shows further aspects of the Then part of the rule. For example, an increase in Item Quantity or Item Price may be selected. In the illustrated example, Item Quantity has been checked at 630 for an increase. A desired increase in the selected aspect (in this case, the quantity of items listed for sale) can be entered in box 632. Assuming no other aspects of the rule are applicable (e.g. a But condition) the increase in the quantity of items listed for sale will take effect once the If conditions have been satisfied.

In FIG. 6J, one the pricing plan has been created, the user can select the plan, which is then attached to or associated with the listing. Plans can be saved (for example, the Piers1 plan) at box 634 so they can be used for other listings or any future listings. In some examples, the use of a saved plan can occur through a Revise your Item (“RYI”) flow. In FIG. 6K, a user can select the dates of when the plan is to be active for a particular listing. Example interface elements 636 allow date selection data to be entered and received.

### Example Methods

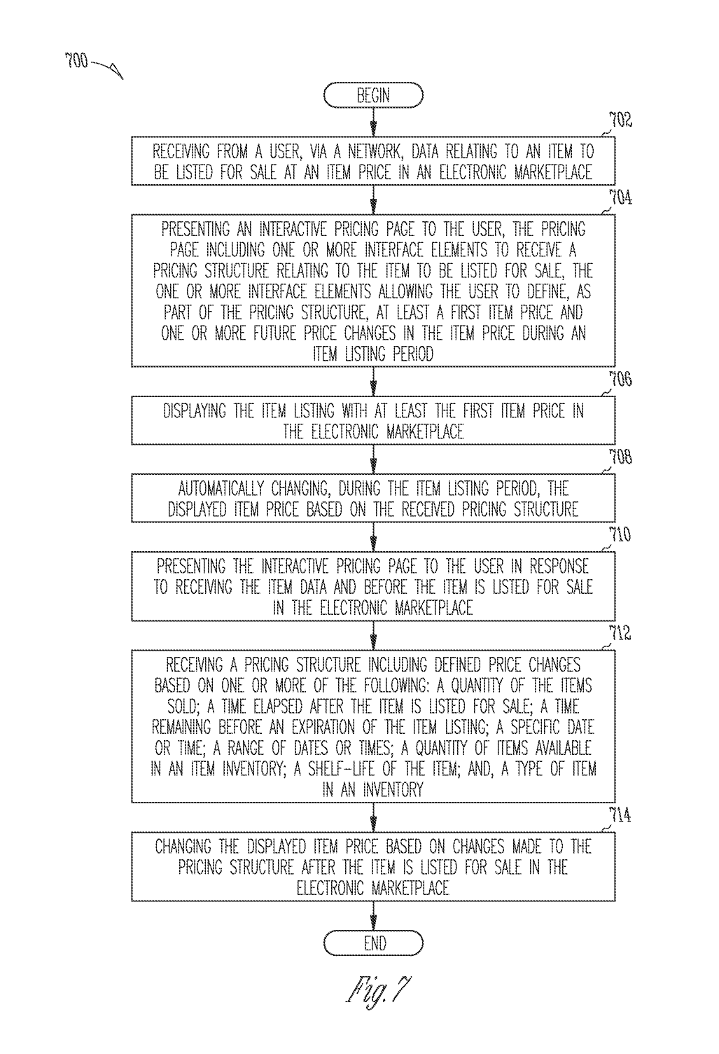

FIG. 7 illustrates an example method for on-line listings of items for sale and the creation of associated item pricing structures. Some portions of the methods may be performed by processing logic that may comprise hardware (e.g., dedicated logic, programmable logic, microcode, etc.), software (such as that which may be run on a general-purpose computer system or a dedicated machine), or a combination of both. In one example embodiment, the processing logic resides at one or more of the application servers 418 illustrated in FIG. 4, or in the multiple listing engine 120 illustrated in FIG. 5. Some portions of the methods may be performed by the various example modules discussed above with reference to FIGS. 4-5. Each of these modules may comprise processing logic.

As shown in FIG. 7, a computer-implemented method 700 comprises at operation 702, receiving from a user, via a network, data relating to an item to be listed for sale at an item price in an electronic marketplace; at 704, presenting an interactive pricing page to the user, the pricing page including one or more interface elements to receive a pricing structure relating to the item to be listed for sale, the one or more interface elements allowing the user to define, as part of the pricing structure, at least a first item price and one or more future price changes in the item price during an item listing period; at 706, displaying the item listing with at least the first item price in the electronic marketplace; and at 708, automatically changing, during the item listing period, the displayed item price based on the received pricing structure.

In some examples, the interactive pricing page is presented at 710 to the user in response to receiving the item data and before the item is listed for sale in the electronic marketplace. In some examples, the method 700 further comprises at 712 receiving a pricing structure including defined price changes based on one or more of the following: a quantity of the items sold; a time elapsed after the item is listed for sale; a time remaining before an expiration of the item listing; a specific date or time; a range of dates or times; a quantity of items available in an item inventory; a shelf-life of the item; and, a type of item in an inventory.

In some examples, the interface elements allow the user to amend the price change basis, or to define a new price change basis, after the item is listed for sale in the electronic marketplace. In some examples, the interface elements allow the user to save the pricing structure in a database and to retrieve the saved pricing structure for potential selection when making future item listings.

In some examples, the operation 708 of automatically changing the displayed item price includes at 714 changing the displayed item price based on changes made to the pricing structure after the item is listed for sale in the electronic marketplace. In some examples, the electronic marketplace is a multi-seller marketplace, and the method 700 further comprises receiving a plurality of pricing structures from a plurality of sellers. In some examples, the method 700 further comprises charging the user a fee for using the interactive pricing page. The interactive pricing page may be presented in the display of a portable electronic device.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

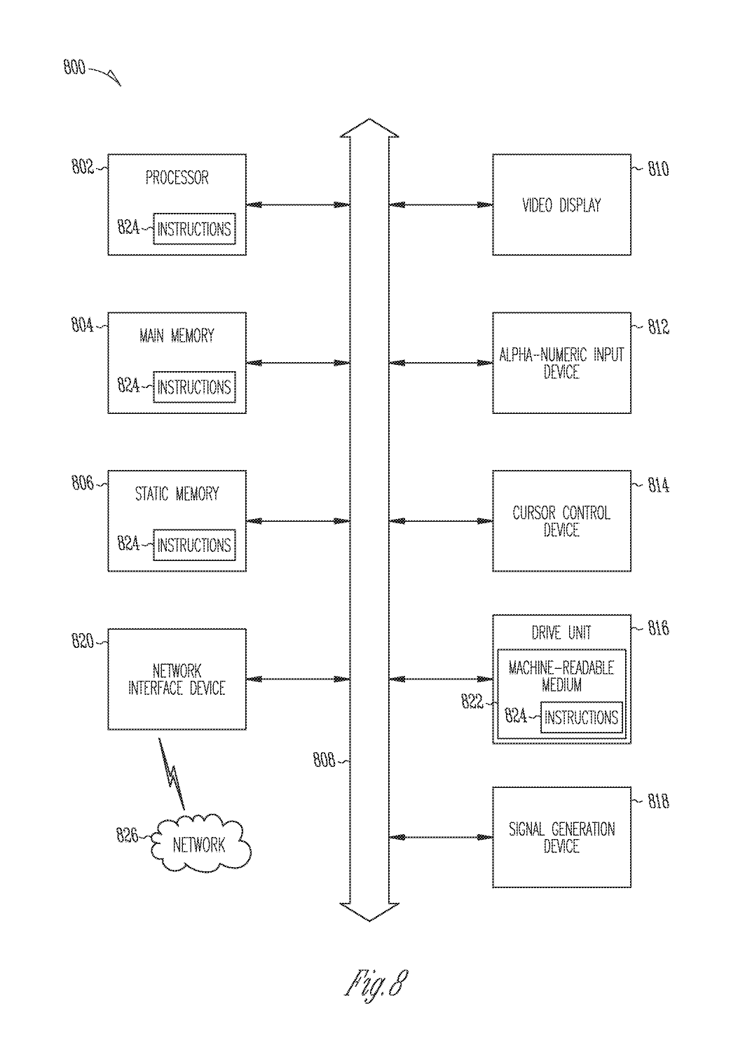

FIG. 8 is a block diagram of machine in the example form of a computer system 900 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a user interface (UI) navigation device 814 (e.g., a mouse), a disk drive unit 816, a signal generation device 818 (e.g., a speaker) and a network interface device 820.

### Machine-Readable Medium

The disk drive unit 816 includes a machine-readable medium 822 on which is stored one or more sets of instructions and data structures (e.g., software) 824 embodying or used by any one or more of the methodologies or functions described herein. The instructions 824 may also reside, completely or at least partially, within the main memory 804, static memory 806, and/or within the processor 802 during execution thereof by the computer system 800, the main memory 804 and the processor 802 also constituting machine-readable media.

While the machine-readable medium 822 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example, semiconductor memory devices (e.g., Erasable Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

### Transmission Medium

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a LAN, a WAN, the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” and “third,” and so forth are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

That which is claimed:

1. A method comprising:
providing one or more pages that includes a plurality of user entry fields that allow a user to enter data relating to an item to be listed for sale in an electronic marketplace and an interactive element that allows a user to indicate a desire for an interactive pricing plan;
in response to receiving an indication from the user for an interactive pricing plan, providing an interactive pricing page that includes:
one or more interface elements to receive a pricing structure relating to the item to be listed for sale that allows the user to define:
a first item price,
a future price of the item price during an item listing period, and
a price change condition,
the interface elements further allowing the user to amend the price change condition or to define a new price change condition after the item is listed for sale in the electronic marketplace,
the interface elements further allowing the user to name and save the pricing structure as a saved pricing plan, and
the interface elements further allowing the user to retrieve a previously saved pricing plan via a name associated with the previously saved pricing plan for potential selection when making future item listings;
providing the item listing in the electronic marketplace with at least the first item price;
determining the occurrence of the price change condition; and
automatically changing the item listing in the electronic marketplace to include the future price in place of the first item price.

2. The method of claim 1, wherein the price change condition comprises a plurality of price change conditions, and wherein determining the occurrence of the price change condition comprises the determining the occurrence of one or more of the plurality of price change conditions.

3. The method of claim 1, wherein the future price comprises a plurality of future prices, and wherein changing the item listing in the electronic marketplace to include the future price in place of the first item price comprises changing the item listing in the electronic marketplace to include one of the future prices of the plurality of future prices in place of the first item price.

4. The method of claim 1, wherein the interactive pricing page is presented to the user in response to receiving the item data and before the item is listed for sale in the electronic marketplace.

5. The method of claim 1, wherein the one or more price change conditions includes at least one quantity selected form the list consisting of: a quantity of the items sold, a time elapsed after the item is listed for sale; a time remaining before an expiration of the item listing; a specific date or time; a range of dates or times; a quantity of items available in an item inventory; a shelf-life of the item; and a type of item in an inventory.

6. The method of claim 1, wherein the interface elements allow the user to save the pricing structure in a database.

7. The method of claim 1, wherein the interface elements allow a user to retrieve a saved pricing structure for potential selection when making future item listings.

8. The method of claim 1, wherein the electronic marketplace is a multi-seller marketplace, and the method further comprises receiving a plurality of pricing structures from a plurality of sellers.

9. The method of claim 1, further comprising charging the user a fee for using the interactive pricing page.

10. The method of claim 1, wherein the interactive pricing page is presented in the display of a portable electronic device.

11. The method of claim 1, wherein the interactive pricing page comprises a page within a smartphone application.

12. The method of claim 1, wherein the interactive pricing page comprises a webpage.

13. A system comprising:
a network interface;
a data storage; and
a processor coupled with the network interface and the data storage, the processor configured to:
provide one or more pages through the network interface that includes a plurality of user entry fields that allow a user to enter data relating to an item to be listed for sale in an electronic marketplace and an interactive element that allows a user to indicate a request for an interactive pricing plan;
receive user entered data relating to an item to be listed for sale in an electronic marketplace and an indication for an interactive pricing plan via the network interface;
save the user entered data into the data storage;
in response to receiving an indication for the interactive pricing plan, provide an interactive pricing page, the interactive pricing page including:
one or more interface elements to receive a pricing structure relating to the item to be listed for sale, the one or more interface elements allowing the user to define:
a first item price,
a future price of the item price during an item listing period, and
a price change condition,
the interface elements further allowing the user to amend the price change condition or to define a new price change condition after the item is listed for sale in the electronic marketplace,
the interface elements further allowing the user to name and save the pricing structure as a saved pricing plan,
the interface elements further allowing the user to retrieve a previously saved pricing plan via a name associated with the previously saved pricing plan for potential selection when making future item listings;
receive a user entered first item price, a user entered future price of the item, and a user entered price change condition;
provide the item listing in the electronic marketplace with at least the user entered first item price;
determine the occurrence of the user entered price change condition;
automatically change the item listing in the electronic marketplace to include the user entered future price in place of the user entered first item price; and
provide the item listing in the electronic marketplace with at least the user entered first future price.

14. The system of claim 13, wherein the interactive pricing page is presented to the user in response to receiving the item data and before the item is listed for sale in the electronic marketplace.

15. The system of claim 13, wherein the pricing structure includes defined price changes based on one or more of the following: a quantity of the items sold; a time elapsed after the item is listed for sale; a time remaining before an expiration of the item listing; a specific date or time; a range of dates or times; a quantity of items available in an item inventory; a shelf-life of the item; and, a type of item in an inventory.

16. The system of claim 13, wherein the interface elements allow the user to save the pricing structure in a database and to retrieve the saved pricing structure for potential selection when making future item listings.

17. The system of claim 10, wherein automatically changing the displayed item price includes changing the displayed item price based on changes made to the pricing structure after the item is listed for sale in the electronic marketplace.

18. The system of claim 13, wherein the electronic marketplace is a multi-seller marketplace, and wherein the receiver module receives a plurality of pricing structures from a plurality of sellers.

19. The system of claim 13, wherein the interactive pricing page is presented in the display of a portable electronic device.

20. A non-transitory computer-readable medium including instructions, which when performed by a machine, cause the machine to perform the operations of:
providing one or more pages that includes a plurality of user entry fields that allow a user to enter data relating to an item to be listed for sale in an electronic marketplace and an interactive element that allows a user to indicate a desire for an interactive pricing plan;
in response to receiving an indication from the user for an interactive pricing plan, providing an interactive pricing page, the interactive pricing page including:
one or more interface elements to receive a pricing structure relating to the item to be listed for sale, the one or more interface elements allowing the user to define:
a first item price,
a future price of the item price during an item listing period, and
a price change condition,
the interface elements further allowing the user to amend the price change condition or to define a new price change condition after the item is listed for sale in the electronic marketplace,
the interface elements further allowing the user to name and save the pricing structure as a saved pricing plan,
the interface elements further allowing the user to retrieve a previously saved pricing plan via a name associated with the previously saved pricing plan for potential selection when making future item listings;
providing the item listing in the electronic marketplace with at least the first item price;
determining the occurrence of the price change condition; and
automatically changing the item listing in the electronic marketplace to include the future price in place of the first item price.
